(19) United States
(12) Patent Application Publication
(10) Pub. No.: US 2026/0072747 A1
(43) Pub. Date: Mar. 12, 2026

(54) SYSTEM AND METHOD FOR INTENT-BASED ORCHESTRATION OF GPU RESOURCES

(71) Applicant: Aarna Networks Inc., San Jose, CA (US)

(72) Inventors: Sriram RUPANAGUNTA, Bangalore (IN); Amar KAPADIA, San Jose, CA (US); Sandeep SHARMA, Bangalore (IN); Vikas KUMAR, Bangalore (IN); Milind JALWADI, Pune (IN)

(73) Assignee: Aarna Networks Inc., San Jose, CA (US)

(21) Appl. No.: 19/252,248

(22) Filed: Jun. 27, 2025

(30) Foreign Application Priority Data
Sep. 6, 2024 (IN) 202441067671

(51) Int. Cl. G06F 9/50

(52) U.S. Cl. CPC G06F 9/5027

(57) ABSTRACT

A system (106) and method (400) for intent-based orchestration of graphics processing unit (GPU) resources are disclosed. The method (400) involves receiving one or more high-level intents from one or more users (102), wherein the one or more high-level intents indicate the GPU-resource requirement of the one or more users (102). The one or more high-level intents are interpreted to derive contextual meaning associated with user-defined requirements. Based on the interpreted intents, the one or more high-level intents are translated into a predefined one or more GPU resources (210). The translated one or more GPU resources (210) are then provisioned in isolated manner to fulfil the GPU-resource requirement of the one or more users (102) such that intent-based orchestration of the GPU resources is achieved.

### FIELD OF THE INVENTION

The present disclosure generally relates to a field of Graphics Processing Unit (GPU) orchestration and resource management, and more particularly, to a system and a method for intent-based orchestration of GPU resources.

### BACKGROUND

GPUs are becoming increasingly vital in the realm of Machine Learning (ML) and Generative Artificial Intelligence (AI), specifically for tasks such as Large Language Model (LLM) training and inference. Such sophisticated workloads demand substantial computational power, which GPUs are uniquely capable of providing due to their parallel processing capabilities. As the dependence on GPUs intensifies, it is imperative to consider the economic and practical aspects of their deployment in data centers and other computational environments.

Given the substantial investment associated with GPUs, it is more economical to share these resources across multiple users or tenants. Such an approach maximizes resource utilization and reduces costs. However, the shared use of GPUs introduces significant challenges, particularly in terms of security and performance. Ensuring that multiple tenants can securely and efficiently share GPU resources without compromising on the performance of their respective workloads is a non-trivial problem.

Current technological frameworks exhibit several limitations that impede the effective use of GPUs in a multi-tenant environment. One major gap is the lack of robust support for multi-tenancy, which is essential for allowing multiple users to securely share the same hardware resources. Another critical gap lies in the absence of self-service and on-demand APIs that enable users to dynamically request and utilize GPU resources as needed. Furthermore, the capability for dynamic partitioning of hardware resources is underdeveloped, yet it is crucial for allocating GPUs in a way that aligns with the fluctuating demands of different workloads.

Different ML and AI workloads have varying requirements that often involve a combination of GPUs, Central Processing Units (CPUs), networking bandwidth, and storage capacity. Manually provisioning these resources for each individual workload is not only labour-intensive but also inefficient. The lack of automation in resource provisioning leads to suboptimal use of hardware, increased operational overhead, and delays in workflow execution.

Moreover, determining the exact resource requirements for a given workload is a complex task. Traditional methods, which rely on manual and static estimations, fall short in adapting to the dynamic nature of computational workloads. These methods do not account for the variability in resource demands that can occur during different phases of the execution of a workload. As a result, resources may be either underutilized or over-provisioned, both of which are undesirable outcomes in a high-performance computing environment.

Therefore, in view of the above-mentioned problems, it is desirable to provide a system and a method that may eliminate the above-mentioned problems of the existing solutions.

### SUMMARY

This summary is provided to introduce a selection of concepts, in a simplified format, that are further described in the detailed description of the present disclosure. This summary is neither intended to identify key or essential inventive concepts of the present disclosure nor is it intended for determining the scope of the present disclosure.

The present disclosure discloses a system and a method for intent-based orchestration of Graphics Processing Unit (GPU) resources. The method includes receiving one or more high-level intents from one or more users. The high-level intent indicates the GPU-resource requirement of the one or more users. The method further includes interpreting the one or more high-level intents received from the one or more users. The interpreting indicates parsing plain language descriptions and translating them into specific resource requirements. For example, number of GPUs required for a given workload. The method further includes translating the one or more high-level intents into a predefined one or more GPU resources based on the interpreted one or more high-level intents. The method further includes provisioning the one or more GPU resources based on the translated one or more intents such that the intent-based orchestration of the GPU resources is achieved.

The system includes a memory coupled with at least one processor. The at least one processor is configured to receive one or more high-level intents from one or more users. The high-level intent indicates the GPU-resource requirement of the one or more users. The at least one processor is configured to interpret the one or more high-level intents received from the one or more users. The at least one processor is configured to translate the one or more high-level intents into a predefined one or more GPU resources based on the interpreted one or more high-level intents. The at least one processor is configured to provision the one or more GPU resources based on the translated one or more intents such that the intent-based orchestration of the GPU resources is achieved.

To further clarify the advantages and features of the present disclosure, a more particular description of the present disclosure will be rendered by reference to specific embodiments thereof, which are illustrated in the appended drawings. It is appreciated that these drawings depict only typical embodiments of the present disclosure and are therefore not to be considered limiting of its scope. The present disclosure is described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an environment for an implementation of a system for intent-based orchestration of GPU resources, according to an embodiment of the present disclosure;

FIG. 2 illustrates a schematic diagram depicting an architecture of the system for the intent-based orchestration of GPU resources, according to an embodiment of the present disclosure;

FIG. 3 illustrates a schematic diagram depicting the system for the intent-based orchestration of GPU resources, according to an embodiment of the present disclosure; and

FIG. 4 illustrates a flowchart depicting a method for intent-based orchestration of GPU resources, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

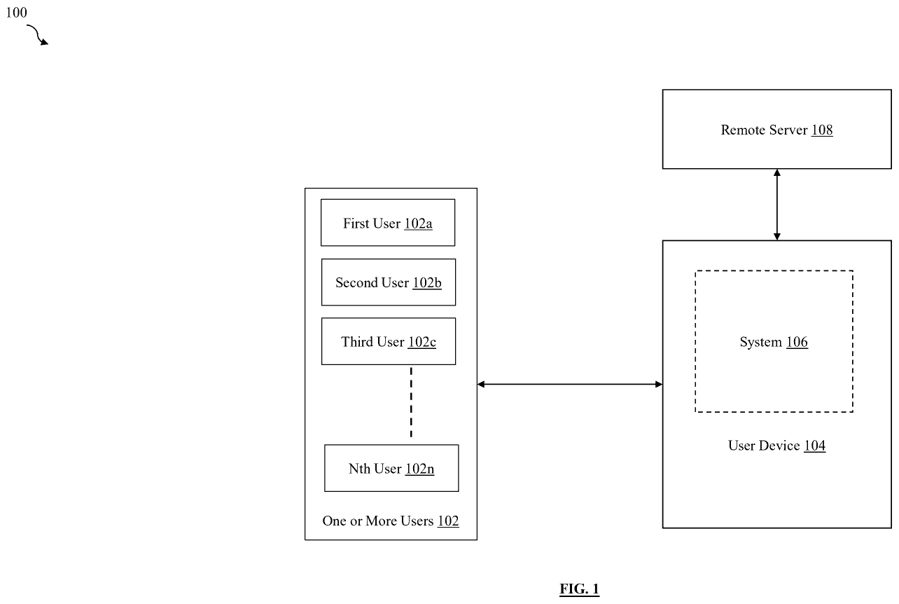

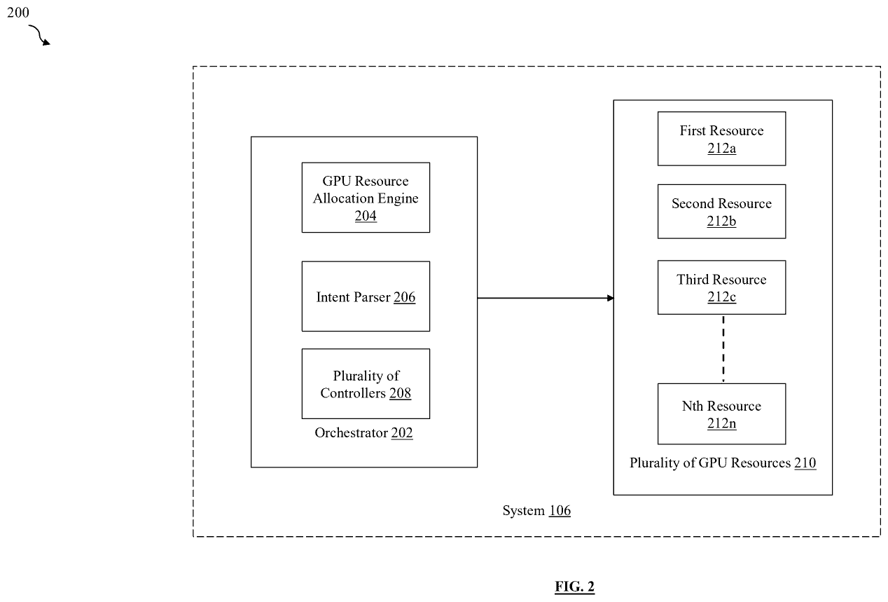

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates an environment 100 for an implementation of a system for the intent-based orchestration of Graphics Processing Unit (GPU) resources, according to an embodiment of the present disclosure.

The environment 100 may include a one or more users 102, a user device 104 associated with the one or more users 102, and a remote server 108 in communication with the user device 104. The one or more users 102 may represented as a first user 102a, a second user 102b, a third user 102c, and up to Nth user 102n.

In an embodiment, the one or more users 102 may interact with the user device 104 by providing suitable commands through an user interface (UI) of the user device 104. In one embodiment, the environment 100 may include the system 106 that may be implemented at the user device 104. In another embodiment, the system 106 may be implemented at the remote server 108.

In a non-limiting example, the user device 104 may include a computer, a desktop, a laptop, a tablet, a fablet, or a smartphone. The user device 104 may be configured to communicate with the remote server 108 through a wired or wireless communication channel such as Wireless Fidelity (Wi-Fi), Bluetooth, Fourth Generation/Fifth Generation (4G/5G), or radio frequency (RF)communication.

In an exemplary embodiment, the one or more users 102 operating the user device 104 may control the system 106 by providing one or more instructions in the form of code or a command. In an exemplary scenario, the user 102a operating the user device 104 may provide an instruction to the system 106 by executing a command such as allocate GPU for model training, or by submitting a configuration file (e.g., in YAML or JSON format) that specifies resource requirements. The command or code may indicate parameters such as the number of GPUs, memory requirements, preferred cloud region, and priority level. The system 106, upon receiving such instructions, interprets the intent and initiates the corresponding orchestration of compute resources.

In another exemplary embodiment, the one or more users 102 may install a predefined application dedicated to the intent-based orchestration of GPU resources on the user device 104. The predefined application may provide the UI on the user device 104 for controlling the system 106 for the intent-based orchestration of GPU resources.

In an embodiment, the intent-based orchestration refers to a process by which the GPU-resource provisioning and management are performed dynamically based on the high-level intents received from the one or more users 102. The high-level intent may be understood as a declarative specification that expresses the desired outcome or goal of the one or more users 102, without explicitly detailing the low-level configuration or execution steps required to achieve that goal.

Further, the system 106 may be configured to interpret, translate, and fulfil the one or more high-level intents by autonomously determining the predetermined GPU resources 210 required to satisfy the declared requirements, such as computational capacity, cost, or geographical preferences. The orchestration is driven by intent recognition and resource abstraction mechanisms integrated into the orchestrator 202.

In an exemplary embodiment, a predefined application may be executed on the user device 104 and may be configured to provide the GUI that allows the one or more users 102 to interact with the system 106 for the intent-based orchestration of GPU resources. For example, the GUI may present the one or more users 102 with selectable input fields such as “Preferred Cost Range,” “Type of GPU Workload” (e.g., training, inference, rendering), and “Preferred Server Location.” Upon entering the selections, the predefined application may be configured to transmit the one or more high-level intents to the orchestration engine 202. In this example, the user may specify a requirement for “low-cost GPU suitable for deep learning inference located in Europe.” The system 106, upon receiving the one or more high-level intents, may be configured to interpret the requirement, map it to the one or more GPU resources 210 that satisfies the intent, and provision such resource automatically. In an embodiment, the system 106 may be configured to receive the one or more high-level intents from the one or more users 102. The one or more high-level intents indicate the GPU-resource requirement of the one or more users 102. In an embodiment, the one or more requirements include a cost for the GPU-resource, a GPU workload, and a geographical location of a GPU server.

In an embodiment, the cost for the GPU-resource refers to the monetary expenditure associated with provisioning and utilizing the GPU resources 210 by the one or more users 102. The cost may encompass various pricing dimensions including, but not limited to, hourly or per-minute usage rates, subscription-based access, spot instance pricing, or bundled package costs as determined by the cloud service provider or infrastructure management platform. The cost may further reflect the class or tier of the GPU hardware, the duration of usage, and whether the GPU resource is dedicated or shared. The orchestrator 202 may be configured to evaluate the cost constraints provided as part of the high-level intents and select from among the predefined GPU resources 210 that align with the budgetary requirements of the one or more users 102.

In an embodiment, the GPU workload refers to the nature and computational intensity of the task or application that is intended to be executed on the predefined one or more GPU resources 210.

Examples of the GPU workloads include deep learning training, inference, image processing, scientific simulation, video rendering, cryptographic hashing, and other parallelizable compute-intensive operations. Each type of GPU workload may have specific performance requirements such as high memory bandwidth, low-latency compute, or large-scale tensor operations. The orchestrator 202 may be configured to interpret the GPU workload specified as part of the high-level intent and translate it into a suitable GPU profile, enabling the provisioning of an appropriate GPU resource 210 optimized for the corresponding workload.

In an embodiment, the geographical location of the GPU server refers to the physical or logical region in which the backend server hosting the GPU resource 210 is deployed. The geographical location may be defined using parameters such as data centre region (e.g., United States (US)-East, European Union (EU)-West), country, latency zone, or proximity to the user device 104. Considerations related to the geographical location may include regulatory compliance, data sovereignty, network latency, availability zones, or user preferences for performance optimization. The orchestrator 202 may be configured to match the user-specified location intent with available GPU servers and provision the predefined one or more GPU resources 210 that are deployed in or closest to the selected geographical location.

Further, the system 106 may be configured to interpret the one or more high-level intents received from the one or more users 102.

The system 106 may be further configured to translate the one or more high-level intents into the predefined one or more GPU resources based on the interpreted one or more high-level intents.

In one embodiment, the system 106 may be further configured to map the one or more high-level intents to the predefined one or more GPU resources.

The system 106 may be further configured to provision the one or more GPU resources based on the translated one or more high-level intents such that the intent-based orchestration of the GPU resources is achieved.

In an embodiment, the provisioning the one or more GPU resources refers to the allocation, configuration, and initiation of the predefined one or more GPU resources 210 that are identified as suitable for execution based on the interpreted and translated intents received from the one or more users 102.

In a non-limiting embodiment, the provisioning the one or more GPU resources may further include initiating container-based execution environments or virtual machine instances on the target GPU server, configuring environment variables, setting up runtime dependencies, and establishing secure communication links between the predefined one or more GPU resource 210 and the user device 104. Configuration data, credentials, and execution scripts may be dynamically injected into the provisioned environment.

In an embodiment, the provisioning of the one or more GPU resources is performed with resource isolation. The resource isolation refers to the logical or physical separation of the provisioned one or more GPU resources to ensure that concurrent usage by the one or more users does not result in performance degradation, data leakage, or unauthorized access.

In an example, the resource isolation may be achieved using hardware-level partitioning techniques such as Multi-Instance GPU (MIG). In another example, the resource isolation may be achieved using container-based execution environments with dedicated GPU allocation. In yet another example, the resource isolation may be achieved by virtualization of the one or more GPU resources using hypervisors or virtual GPUs (vGPUs). The system 106 may be further configured to monitor the provisioned one or more GPU resources. The system 106 may be configured to identify an updated GPU resource requirement during the monitoring of the provisioned one or more GPU resources. Based on the identifying the updated one or more GPU resources requirement, the system 106 may be configured to modify the provisioned one or more GPU resources.

In various embodiments, the system 106 for the intent-based orchestration will be discussed in detail in conjunction with FIG. 2.

FIG. 2 illustrates the schematic diagram depicting an architecture 200 of the system 106 for the intent-based orchestration of the GPU resources, according to an embodiment of the present disclosure.

In an embodiment of the present disclosure, the architecture 200 may be implemented to achieve intelligent, dynamic, and cost-efficient orchestration of GPU resources based on user intents. The architecture 200 may include an orchestrator 202 and a plurality of GPU resources 210. The orchestrator 202 may further include a GPU resource allocation engine 204, an intent parser 206, and a plurality of controllers 208. The plurality of GPU resources 210 may further include a first resource 212a, a second resource 212b, a third resource 212c, and so on up to an nth resource 212n.

In an embodiment, the GPU resource allocation engine 204 may be configured to select the most suitable GPU resource configuration from the plurality of resources based on the translated specifications. The selection process may involve optimization based on cost, latency, availability, and compliance with policy rules. The GPU resource allocation engine 204 may be configured to support both single-resource and distributed resource allocation strategies depending on the requirements.

In an embodiment, the intent parser 206 may be configured to receive and process the one or more high-level intents from the one or more users 102. The one or more high-level intents indicate the GPU-resource requirement of the one or more users 102. The intent parser 204 may be adapted to tokenize, normalize, and extract structured data from such intents. The structured intent data may be passed to the intent parser 206.

The plurality of controllers 208 may be configured to receive resource allocation instructions from the GPU resource allocation engine 204. The resource allocation instructions may include one or more translated GPU resource specifications derived from the interpreted one or more high-level intents of the one or more users 102.

The plurality of controllers 208 may be further configured to execute one or more low-level provisioning or management commands to the corresponding GPU environments.

In an embodiment of the present disclosure, the plurality of resources 210 may refer to a distributed set of compute and acceleration infrastructure components that include the one or more GPU resources. The one or more GPU resources may be defined as hardware or virtualized graphical processing units configured to execute compute-intensive tasks. The compute-intensive tasks may include artificial intelligence (AI) inference, training, graphical rendering, or general-purpose GPU computation.

In one embodiment, the plu rality of GPU resources 210 may include a first resource 212a, a second resource 212b, a third resource 212c, and so on upto nth resource 212n.

The plurality of GPU resources 210 may include, but not be limited to, discrete GPUs hosted in cloud environments, GPU-enabled virtual machines, containerized GPU instances, on-premise GPU nodes in data centres, edge devices with integrated GPUs, and shared GPU clusters managed through orchestration platforms such as Kubernetes, Simple Linux Utility for Resource Management (Slurm), or proprietary vendor systems.

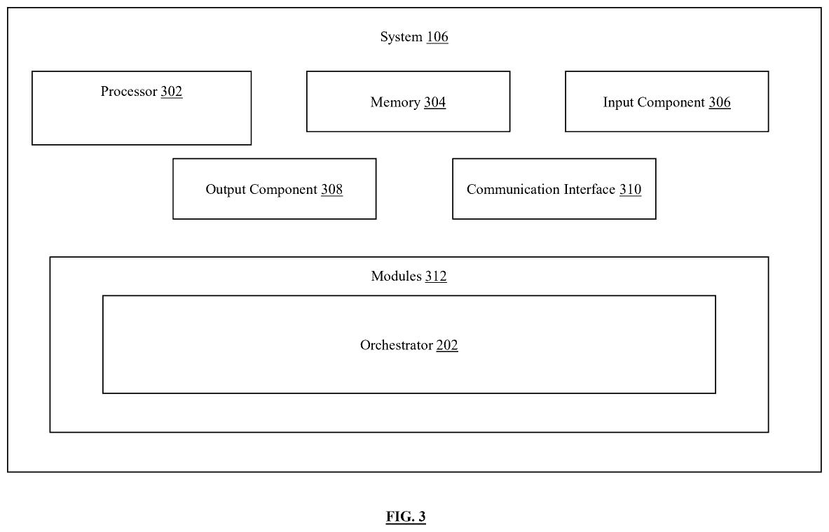

In various embodiments, the system 106 for the intent-based orchestration of the GPU resources may be discussed in detail in conjunction with FIG. 3.

FIG. 3 illustrates the schematic diagram depicting the system 300 for the intent-based orchestration of GPU resources, according to an embodiment of the present disclosure.

In an embodiment of the present disclosure, the system 106 may be deployed at the user device 104.

The system 106 may include but is not limited to, one or more processors 302 (referred to as the “processor 302”), a memory 304, an input component 306, an output component 308, a communication interface 310, and one or more modules 312.

The one or more processors 302 may be a single processing unit or several units, all of which could include multiple computing units. The one or more processors 302 may be implemented as one or more microprocessors, microcomputers, microcontrollers, digital signal processors, central processing units, state machines, logic circuitries, and/or any devices that manipulate signals based on operational instructions. Among other capabilities, the one or more processors 302 are adapted to fetch and execute computer-readable instructions and data stored in the memory 304.

In one embodiment, the memory 304 may include suitable logic, circuitry, and interfaces that may be configured to store data associated with the system 106 for the intent-based orchestration of GPU resources, machine learning modules, and other data related to the intent-based orchestration of GPU resources. Examples of the memory 304 may include, but are not limited to, a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory 304 in the system 306, as described herein. In other embodiments, the memory 304 may be realized in the form of a database or a cloud storage working in conjunction with the processor 302, without deviating from the scope of the disclosure.

The input component 306 may be configured to receive information, such as user input. For example, the input component 306 may include, but not be limited to, a touchscreen display, a keyboard, a keypad, a mouse, a button, a switch, and/or a microphone associated with the system 306.

The output component 308 may be configured to display information from the system 306 to the one or more users 102 or other systems, utilizing a variety of devices and technologies tailored to specific application needs. The output component 308 may include visual output devices such as display screens, Liquid Crystal Displays, Light Emitting Diodes, Organic Light Emitting Diode (LCD, LED, OLED), projectors, and heads-up displays (HUDs) for presenting graphical or textual information. Additionally, auditory output through speakers and headphones provides audio feedback and alerts, while haptic output devices, like vibration motors in smartphones or game controllers, offer tactile feedback. Functionally, the output component 308 serves multiple roles, including displaying graphical user interface (GUI) elements for user interaction, delivering notifications and alerts through sound, visual indicators, or vibrations, and rendering complex data visualizations like charts and graphs for easier comprehension.

In an embodiment, the output component 308 may be configured to receive processed data from the processor 302, which determines the information to be communicated, and the output component 308 may access the memory 304 to retrieve and display stored information such as documents, media files, or application states.

Furthermore, the output component 308 may be configured to meet the specific requirements of different applications, such as high-resolution visual output and immersive audio for gaming systems or clear and precise data visualization and alert mechanisms for industrial control systems. Through these varied output methods, the output component 308 ensures effective communication of information, enhancing both system 106 functionality and user experience.

The communication interface 310 is a hardware and/or software component that may be configured to enable the system 306 to exchange data with other user devices or systems. The communication interface 310 may be configured to serve as the link for transmitting and receiving information, either within a local environment (e.g., between components of the same system) or across networks.

The one or more modules 312, amongst other things, include routines, programs, objects, components, data structures, etc., which perform particular tasks or implement data types. The module(s) 312 may also be implemented as, signal processor(s), state machine(s), logic circuitries, and/or any other device or component that manipulates signals based on operational instructions.

Further, the one or more modules 312 may be implemented in hardware, instructions executed by a processing unit, or by a combination thereof. The processing unit can comprise a computer, a processor, such as the one or more processors 302, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the one or more modules 312 may be machine-readable instructions (software) which, when executed by the processor/processing unit 302, perform any of the described functionalities.

In an embodiment, the one or more modules 312 may include the orchestrator.

In operation, the processor 302 may be configured to receive the one or more high-level intents from the one or more users 102. The one or more high-level intents indicate the GPU-resource requirement of the one or more users 102. In an embodiment, the one or more requirements include a cost for the GPU-resource, a GPU workload, and a geographical location of a GPU server.

In an embodiment, the one or more high-level intents may include one or more qualitative or quantitative preferences such as the type of workload (e.g., training or inference), cost constraints (e.g., maximum price per GPU-hour), preferred geographical location (e.g., North America or specific data centre regions), or performance expectations (e.g., low latency, high throughput).

In an exemplary embodiment, the first user 102a may initiate the request through the system 106 for executing an AI-based image classification task. The high-level intent associated with this request may include a preference for executing the GPU workload in a North American region, utilizing the GPU resources costing no more than $2 per GPU-hour, and completing inference workloads with minimal latency.

The one or more high-level intents may be expressed in a declarative manner, for example: “Run inference workload for image classification in North America with budget GPU option and minimal latency”.

Upon receiving the one or more high-level intents from the one or more users 102, the processor 302 may be configured to interpret the one or more high-level intents received from the one or more users 102. The interpretation of the one or more high-level intents may be performed by the intent-parser 206 associated with the orchestrator 202.

In an exemplary scenario, if the user 102b intends to perform a complex computational task such as running a deep learning model on a large dataset, the high-level intent could be expressed as “execute deep learning model on GPU cluster.” The interpretation of the one or more high-level intents may be performed by the intent-parser 206 associated with the orchestrator 202. In this case, the intent-parser 206 may be configured to analyze the high-level intent to identify the required resources, such as the need for GPU resources and the specific computational power necessary for the deep learning model. The analysis enables the orchestrator 202 to translate the user's intent into specific resource allocation requirements, such as the identification of suitable GPU clusters, the type of memory required, and other performance constraints (e.g., processing time, energy consumption) for optimal execution of the task.

Upon interpreting the one or more high-level intents, the processor 302 may be configured to translate the one or more high-level intents into the predefined one or more GPU resources based on the interpreted one or more high-level intents.

In one embodiment, the processor 302 may be further configured to map the one or more high-level intents to the predefined one or more GPU resources to translate the one or more high-level intents.

For example, the user 102c may submit the intent “train deep neural network model on a multi-GPU setup.” The processor 302, upon receiving this high-level intent, understands that the user 102c requires the use of multiple GPUs for parallel training. Based on this interpretation, the processor 302 may be configured to translate the high-level intent into the predefined GPU resources, such as a specific set of GPU clusters that meet the computational and memory requirements for training the neural network model.

For example, if the interpreted intent is to “optimize a machine learning model for large-scale data processing,” the processor 302 may map this intent to GPU resources with higher memory bandwidth and larger VRAM capacities, such as selecting a set of GPUs capable of handling large data throughput. The mapping ensures that the right GPU resources are allocated to execute the task efficiently, considering both the processing power and memory requirements of the task.

Upon translating the one or more high-level intents, the processor 302 may be further configured to provision the one or more GPU resources based on the translated one or more high-level intents, such that the intent-based orchestration of the GPU resources is achieved.

For example, suppose a user 102d submits the high-level intent “render 3D graphics for real-time simulation.” After interpreting this intent, the processor 302 may be configured to identify that the task requires GPUs with high processing power for rendering purposes, specifically GPUs with advanced graphical capabilities like NVIDIA Ray Tracing Texel eXtreme (RTX) series. Once the high-level intent is translated into these specific GPU resources, the processor 302 proceeds to provision the identified GPUs by allocating the resource from the plurality of GPU resources 210.

In another embodiment, the processor 302 may be further configured to monitor the provisioned one or more GPU resources. The processor 302 may be configured to identify an updated GPU resource requirement during the monitoring of the provisioned one or more GPU resources. Based on the identifying the updated one or more GPU resources requirement, the system 106 may be configured to modify the provisioned one or more GPU resources.

For example, consider a scenario where a user 102e has submitted the high-level intent to “run real-time video analytics on streaming surveillance data.” Initially, the processor 302 provisions two GPUs based on the anticipated workload for standard resolution video streams. However, during execution, the processor may be configured to identify an increased computational load due to a sudden change in input such as multiple high-resolution streams or a spike in object detection frequency. Consequently, the processor 302 modifies the provisioned resources by dynamically scaling up the GPU resource allocation.

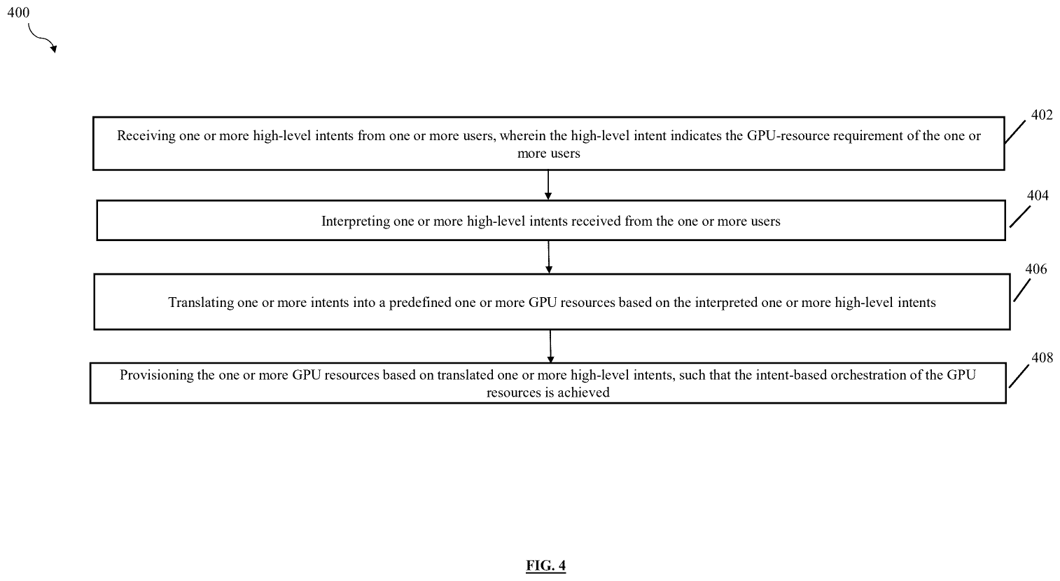

FIG. 4 illustrates a flowchart depicting the method 400 for intent-based orchestration of GPU resources, according to an embodiment of the present disclosure.

At step 402, the method 400 may include receiving the one or more high-level intents from the one or more users 102. The one or more high-level intents indicates the GPU-resource requirement of the one or more users 102.

At step 404, the method 400 may further include interpreting the one or more high-level intents received from the one or more users 102.

At step 406, the method 400 may further include translating the one or more high-level intents into the predefined one or more GPU resources based on the interpreted one or more high-level intents.

At step 408, the method 400 may further include provisioning the one or more GPU resources based on the translated one or more high-level intents such that the intent-based orchestration of the GPU resources is achieved.

One advantage of the present disclosure is that it provides a mechanism for abstracting GPU resource provisioning through the reception and interpretation of high-level intents, rather than requiring the one or more users 102 to manually configure technical infrastructure parameters. This intent-based approach allows for dynamic orchestration of GPU resources that align with user-specified constraints such as cost, workload type, and geographic preferences, thereby improving usability and reducing the operational complexity for the users 102.

Another advantage of the present disclosure is that it enables efficient mapping of the high-level intents to the predefined set of GPU resources through the parsing and the translation mechanism. This mapping process supports flexible interpretation of user preferences and automated alignment with infrastructure capabilities, ensuring that resource provisioning adheres to performance and budgetary expectations without requiring manual oversight.

A further advantage of the present disclosure is that it enables real-time provisioning and scaling of the GPU resources using the plurality of controllers 208, each configured to interact with specific underlying infrastructure providers. The plurality of controllers 208 interpret instructions issued by the orchestrator 202 and autonomously instantiate, modify, or release GPU resources based on the translated high-level intents. This modular architecture promotes multi-cloud operability and seamless integration with diverse infrastructure environments.

Yet another advantage of the present disclosure is that it supports continuous monitoring and dynamic adjustment of the provisioned GPU resources based on changes in workload demand or user intent. Through feedback loops embedded in the system 106, the updated GPU requirements may be identified and acted upon during execution, enabling resource elasticity and cost optimization in real time.

Furthermore, embodiments of the disclosed methods, processes, modules, devices, systems, and computer program products may be readily implemented, fully or partially, in software using, for example, object or object-oriented software development environments that provide portable source code that can be used on a variety of computer platforms. Alternatively, embodiments of the disclosed methods, processes, modules, devices, systems, and computer program products can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the present disclosure to produce additional embodiments. Furthermore, certain features may sometimes be used to advantage without a corresponding use of other features.

I/We claim:

1. A method (400) for intent-based orchestration of graphics processing unit (GPU) resources, the method (400) comprising:
receiving one or more high-level intents from one or more users (102), wherein the one or more high-level intents indicates the GPU-resource requirement of the one or more users (102);
interpreting the one or more high-level intents received from the one or more users (102);
translating the one or more high-level intents into a predefined one or more GPU resources (210) based on the interpreted one or more high-level intents; and
provisioning the one or more GPU resources based on the translated one or more high-level intents such that the intent based orchestration of the GPU resources is achieved.

2. The method (400) as claimed in claim 1, wherein the one or more requirements includes a cost for the GPU-resource, a GPU workload, and a geographical location of a GPU server.

3. The method (400) as claimed in claim 1, wherein the method (400) comprising:
monitoring the provisioned one or more GPU resources.

4. The method (400) as claimed is claim 3, wherein the method (400) comprising:
identifying an updated GPU resource requirement during the monitoring of the provisioned one or more GPU resources; and
modifying the provisioned one or more GPU resources based on the identified updated GPU resource requirement.

5. The method (400) as claimed in claim 1, wherein the translating the one or more high-level intents, the method (400) comprising:
mapping the one or more high-level intents to the predefined one or more GPU resources (210).

6. The method (400) as claimed in claim 1, wherein the provisioning of the one or more GPU resources is performed with resource isolation.

7. A system (106) for intent-based orchestration of graphics processing unit (GPU) resources, the system (106) comprising:
a memory (304);
at least one processor (302) in communication with the memory (304) is configured to:
receive one or more high-level intents from one or more users (102), wherein the one or more high-level intents indicates the GPU-resource requirement of the one or more users (102);
interpret the one or more high-level intents received from the one or more users (102);
translate the one or more high-level intents into a predefined one or more GPU resources (210) based on the interpreted one or more high-level intents; and
provision the one or more GPU resources based on the translated one or more high-level intents such that the intent-based orchestration of the GPU resources is achieved.

8. The system (106) as claimed in claim 7, wherein the one or more requirements includes a cost for the GPU-resource, a GPU workload, and a geographical location of a GPU server.

9. The system (106) as claimed in claim 7, wherein the at least one processor (302) is configured to:
monitor the provisioned one or more GPU resources.

10. The system (106) as claimed is claim 8, the at least one processor (302) is configured to:
identify an updated GPU resource requirement during the monitoring of the provisioned one or more GPU resources; and
modify the provisioned one or more GPU resources based on the identified updated GPU resource requirement.

11. The system (106) as claimed in claim 7, wherein the translating the one or more high-level intents, the at least one processor (302) is configured to:
map the one or more high-level intents to the predefined one or more GPU resources (210).

12. The system (106) as claimed in claim 7, wherein the provisioning of the one or more GPU resources is performed with resource isolation.
